(19) United States
(12) Patent Application Publication
(10) Pub. No.: US 2007/0150295 A1
(43) Pub. Date: Jun. 28, 2007

(54) Asset management system

(75) Inventors: Jay Dawson, Peoria, IL (US); Bhavin Vyas, Peoria, IL (US); Dennis Skarvan, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/315,500

(22) Filed: Dec. 23, 2005

(51) Int. Cl. G06Q 99/00

(52) U.S. Cl. 705/1

(57) ABSTRACT

An asset management system is provided. The system may include one or more data collection devices configured to monitor one or more operating conditions of a leased machine. At least one of the one or more data collection devices may be configured to directly monitor operation of at least one component of the machine to determine the harshness with which the machine is operated. The system may also include a processor configured to receive data from the one or more data collection devices. The processor may also be configured to determine a value of the machine based on the data from the one or more data collection devices. The processor may be further configured to determine fees associated with the lease in real time based on the data from the one or more data collection devices.

### TECHNICAL FIELD

The present disclosure is directed to an asset management system and, more particularly, to an asset management system based on machine data acquisition.

### BACKGROUND

Over time, machines have become more and more technologically sophisticated. The evolution of computing technology, among other things, has spawned the development of better performing machines by facilitating more control of machine operating systems. Improved control may be enabled, in some cases, by monitoring the operating parameters of a system or component in “real time.” Such monitoring may enable a system to respond in a precise and virtually immediate manner to maintain operating parameters within desired specifications.

Machine owners may be concerned with various aspects of machine operation, such as machine performance, operator conduct (e.g., abuse, productivity, etc.), efficiency, machine health, etc. In some cases, such as with leased vehicles, an owner may be particularly concerned with resale value of a machine. The same or similar types of monitoring equipment that are used to regulate performance of a machine may also be used to record operating conditions data that may be used to monitor the various aspects of machine operation mentioned above. Data acquisition such as this may be used to determine how much a machine is being used. Systems have been developed that make use of such data acquisition in determining lease rates. Other systems have been developed to determine resale prices of leased equipment based on certain monitored operating conditions. For example, U.S. Pat. No. 5,970,436 to Berg et al. (“the '436 patent”), discloses determining a resale price of a piece of equipment, based on engine operation time and a motion sensor configured to detect vibration of the equipment, thereby indirectly monitoring engine idle time.

While the '436 patent may disclose determining a resale price of a machine, the '436 patent does not disclose directly monitoring operation of at least one component of the machine to determine the harshness with which the machine is operated. Rather, the '436 patent discloses a motion sensor configured to detect when the machine is actively in use as opposed to simply idling. While this determination may provide some indirect indication of the operating conditions of the machine (i.e., idling vs. non-idling), it does not provide any quantitative indication of the harshness with which the machine is used. A quantification of the harshness with which the machine is used could facilitate a more accurate determination of the value of a machine, and thus enable a more appropriate resale price to be set.

The present disclosure is directed to overcoming one or more of the problems set forth above.

### SUMMARY OF THE INVENTION

In one aspect, the present disclosure is directed to an asset management system. The system may include one or more data collection devices configured to monitor one or more operating conditions of a leased machine. At least one of the one or more data collection devices may be configured to directly monitor operation of at least one component of the machine to determine the harshness with which the machine is operated. The system may also include a processor configured to receive data from the one or more data collection devices. The processor may also be configured to determine a value of the machine based on the data from the one or more data collection devices. The processor may be further configured to determine fees associated with the lease in real time based on the data from the one or more data collection devices.

In another aspect, the present disclosure is directed to a method of determining a resale price of a leased machine. The method may include directly monitoring operation of at least one component of the machine including collecting data for one or more operating conditions of the machine. The directly monitored operation of the at least one component may be directly indicative of a harshness with which the machine is operated. The method may also include determining a value of the machine based on the collected data. The method may further include determining fees associated with the lease in real time based on the collected data.

### BRIEF DESCRIPTION OF THE DRAWINGS

FIG. 1 is a diagrammatic illustration of an asset management system according to an exemplary disclosed embodiment.

FIG. 2 is a block diagram representation of an asset management system according to an exemplary disclosed embodiment.

FIG. 3 is a block diagram illustrating factors considered by a system processor in determining lease rates and/or resale price.

### DETAILED DESCRIPTION

Reference will now be made in detail to the drawings. Wherever possible, the same reference numbers will be used throughout the drawings to refer to the same or like parts.

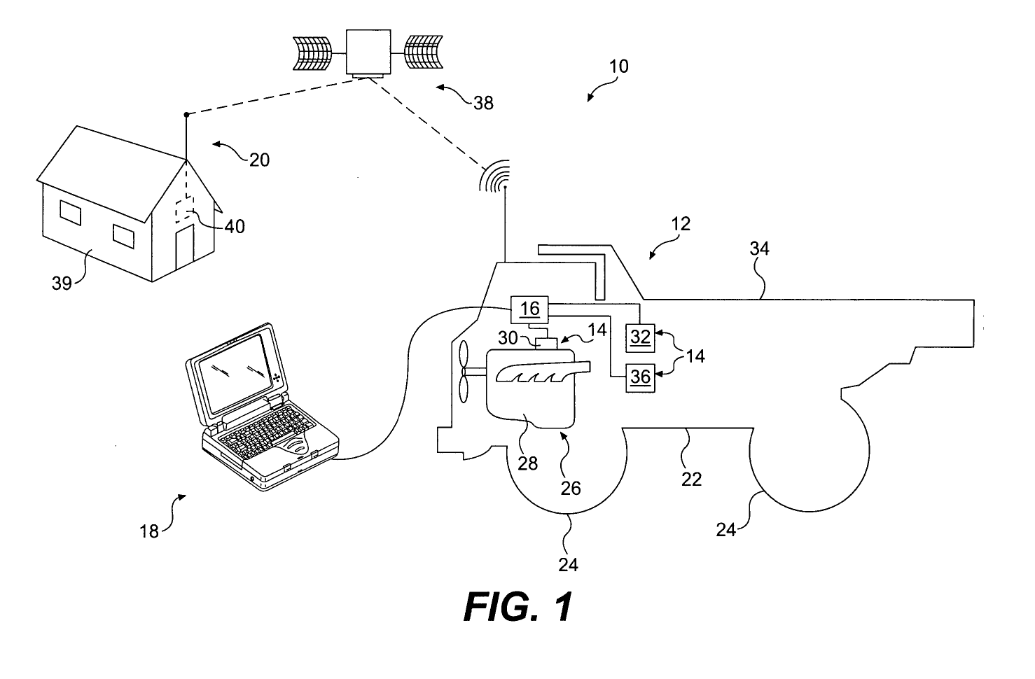

FIG. 1 shows an asset management system 10. System 10 may include a machine 12. System 10 may also include data collection devices 14, a controller 16, and a means for offloading data from machine 12. Such means may include, for example, a hardware interface device 18 or an over-the-air transmission receiving device 20.

Machine 12 may include a frame 22, one or more traction devices 24, and a power source 26. Accordingly, traction devices 24 may be any type of traction devices, such as, for example, wheels, as shown in FIG. 1, tracks, belts, or any combinations thereof. Although machine 12 is shown as a truck, machine 12 could be any type of machinery which degrades in performance or condition over time.

Power source 26 may include any type of power source. Power source 26 is illustrated as an internal combustion engine 28. Power source 26 may include any type of internal combustion engine, such as gasoline engines, diesel engines, natural gas engines, etc. Although power source 26 is illustrated as an internal combustion engine, alternatively, power source 26 could include other types of power sources such as a fuel cell or an electrical power source, such as a battery. Power source 26 could also include a hybrid power system, combining, for example, an internal combustion engine with a battery.

Data collection devices 14 may include any kind of sensors or other types of monitoring equipment suitable for monitoring one or more operating conditions of machine 12. In some embodiments, data collection devices 14 may be configured to monitor operating conditions that are indicative of the harshness with which machine 12 is operated. In one aspect, data collection devices 14 may be configured to monitor one or more operating parameters of machine 12. For example, system 10 may include an engine monitoring device 30 configured to monitor one or more operating parameters of engine 28. Exemplary engine operating parameters that may be monitored by engine monitoring device 30 include engine hours (i.e., the amount of time the engine runs), engine speed and idle time, as well as harshness indicators, such as engine load, etc.

Data collection devices 14 may also include other equipment for monitoring other operating parameters of machine 12. For example, machine 12 may include a work implement sensor 32. Work implement sensor 32 could be any type of sensor for monitoring the operation of a work tool, such as a bucket, blade, claw, etc. Work implement sensor 32 may be configured to monitor the number of times (repetitions), speed, and/or the load at which a work implement is operated. As shown in FIG. 1, work implement sensor 32 may be configured to monitor the operation of a dump body 34 of machine 12. For example, work implement sensor 32 may be configured to monitor the number of times and/or the speed at which dump body 34 is raised and lowered. Data collected from such monitoring may indicate harshness of operation of machine 12.

Data collection devices 14 may also include other equipment for monitoring other aspects of machine 12, such as transmissions, suspension, and actuators. Other aspects that may be monitored to determine harshness of operation may include temperatures, pressures, and/or levels of various fluids, such as engine oil, hydraulic fluid, coolant, etc. For example, suspension pressure (e.g., within shocks or struts of machine 12) may be monitored to determine a payload being transported by a hauling vehicle, such as machine 12. Payload data may provide insight into wear and tear on machine 12, and thus the harshness of operation. Alternatively or additionally, suspension pressure could be monitored to determine the roughness of terrain over which machine 12 travels, which may be yet another indicator of the harshness with which machine 12 is utilized.

Machine 12 may also be equipped with one or more atmospheric sensors 36 to monitor other types of operating conditions of machine 12. For example, atmospheric conditions, such as temperature, humidity, precipitation, etc. may be monitored. Other atmospheric conditions may also be monitored, such as dust and other particulates in the air. These and other types of atmospheric conditions may indicate harshness of operation.

Other operating conditions that may be monitored may include geographic parameters, such as information about geographic location. For example, machine 12 may be equipped with a positioning device or system (not shown). One such system may be configured for tracking machine 12 via a global positioning system (GPS). Other geographic parameters may also be monitored such as elevation at a worksite and/or incline of surfaces over which machine 12 may travel.

Directly monitoring operation of components and/or systems of machine 12 may provide a direct indication of the harshness with which machine 12 is operated. For example, monitoring repetitions of work implement operation may provide a direct indication of wear and tear on a work implement, and thus the harshness of operation of machine 12. Harshness may also be indicated indirectly, such as by monitoring other types of operating conditions like atmospheric conditions and geographic parameters. For example, atmospheric conditions like humidity, and geographic parameters like altitude may provide indirect indications of harshness of operation.

It should also be noted that more than one of these types of operating conditions may be monitored. For example, machine 12 may be equipped to monitor any combination of operating parameters, geographic parameters, and atmospheric conditions.

Controller 16 may be located anywhere on machine 12 and may include any type of processing device suitable for receiving data from data collection devices 14. Controller 16 may also be configured to facilitate offloading of the data to a location remote from machine 12.

In addition to controller 16, system 10 may include means for offloading data from machine 12. Such means may include a hardware interface device 18 configured to interface with controller 16 or directly with data collection devices 14 to download or otherwise retrieve data from machine 12. For example, hardware interface device 18 may include a laptop or personal digital assistant (PDA) configured to “plug in” to machine 12.

Alternatively or additionally, system 10 may include an over-the-air transmission receiving device 20 configured to retrieve data from machine 12 via “wireless” communication. For example, over-the-air transmission receiving device 20 may include a laptop or PDA configured to retrieve data from machine 12 via a wireless network or Internet connection. In other embodiments, system 10 may be configured to retrieve data from machine 12 from a location remote from machine 12. For example, system 10 may include a satellite 38 configured to receive data from machine 12 and redirect it to a processing center 39 remote from machine 12. Processing center 39 may be located at any distance or location relative to machine 12. For example, processing center 39 may be located at the same work site as machine 12 or at a location remote from the work site.

Although various means and methods for offloading data from machine 12 are described herein, these means and methods are exemplary only. The offloading of data from machine 12 may be accomplished in any suitable manner with any suitable means for doing so.

Whether data is retrieved from machine 12 via hardware interface device 18, over-the-air transmission receiving device 20, or some combination thereof, the retrieved data may be directed to a processor 40. In some embodiments processor 40 may be located on machine 12. In other embodiments, processor 40 may be located remote from machine 12 and at the work site where machine 12 is located. In other embodiments, processor 40 may be located remote from the work site where machine 12 is located. For example, Processor 40 may be integrated with controller 16 on machine 12, integrated with hardware interface device 18, or may be located at processing center 39, which, as described above, can be located at the work site or remote from the work site.

Data collection devices 14 may be configured to monitor operating parameters of machine 12 in real time. For purposes of this disclosure, the term “real time” shall refer to the immediate or substantially immediate availability of data to an information system as a transaction or event occurs. That is, data may be retrieved and available for analysis as quickly as it can be transmitted from machine 12 to processor 40. Such transmissions may be virtually instantaneous or may take a few seconds or minutes to complete.

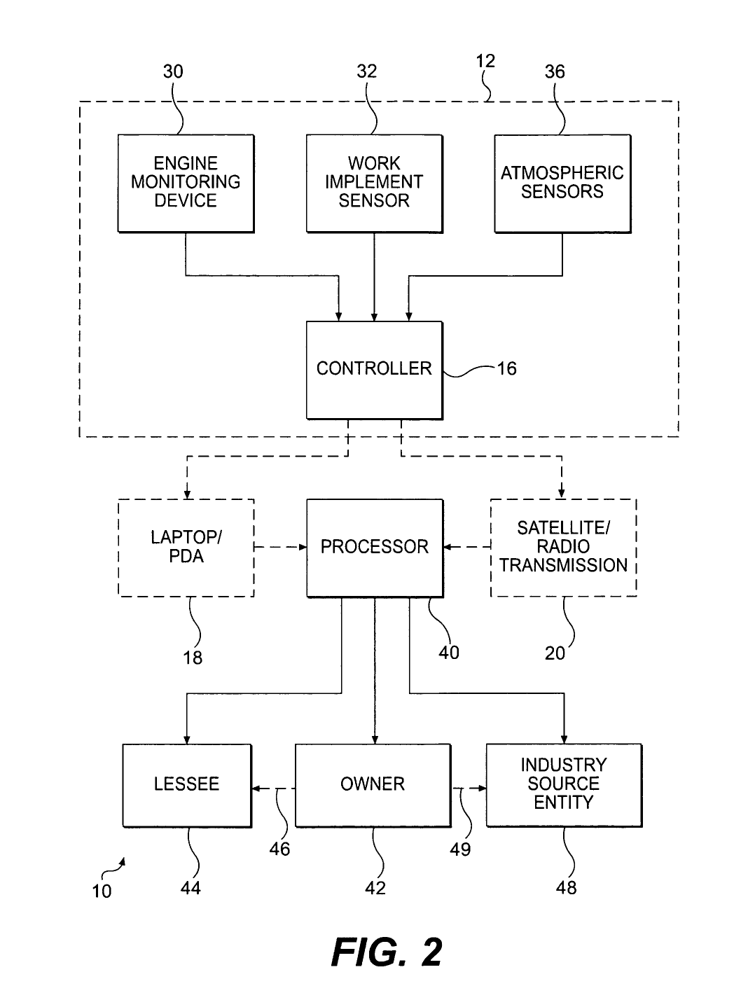

FIG. 2 is a block diagram representation of the flow of data through the various components of system 10. As illustrated by FIG. 2, data may be transmitted from various monitoring equipment, such as engine monitoring device 30, work implement sensor 32, and atmospheric sensors 36, to controller 16. The data may then be transmitted from controller 16 to processor 40 via either hardware interface device 18, over-the-air transmission receiving device 20, or some combination thereof.

Processor 40 may be configured to analyze the data and/or make the data or analysis thereof available for consideration by one or more entities. For example, as illustrated in FIG. 2, the data and/or analysis may be forwarded to an owner 42 of machine 12. As used herein, the term owner is intended to broadly cover any person/entity that has rights or interest of any type in the machine at issue, such as, for example, a person with ownership rights (e.g., title) of such machine, a renter of such machine, lessor or lessee of such machine, a supervisor of the machine operator, or a manager of a worksite at which the machine is operated.

System 10 may be configured to make some or all of the data and/or analysis available to at least one entity other than owner 42. For example, the data and/or analysis may be forwarded by processor 40 to a lessee 44 of machine 12. Alternatively or additionally, owner 42 may forward the data and/or analysis to lessee 44 as indicated by a dashed line 46. In some embodiments, system 10 may be configured to automatically forward the data and/or analysis to lessee 44. In some embodiments, the data and/or analysis may be made available to an industry source entity 48 that provides an industry source for resale values of machines. In this way, entity 48 may utilize the information from system 10 about operation of machine 12 to determine market values of used equipment. The data and/or analysis may be sent to industry source entity 48 from processor 40 or from owner 42, as illustrated by a dashed line 49.

Processor 40 may be configured to receive data from one or more of data collection devices 14 and predict a future market value of machine 12 based on the data from data collection devices 14. Processor 40 may also be configured to determine fees associated with the lease in real time based on the predicted future market value. System 10 may be configured to satisfy such lease fees using a monetary account with which the lease agreement is associated. Processor 40 may also be configured to determine a resale price of machine 12 based on the predicted market value.

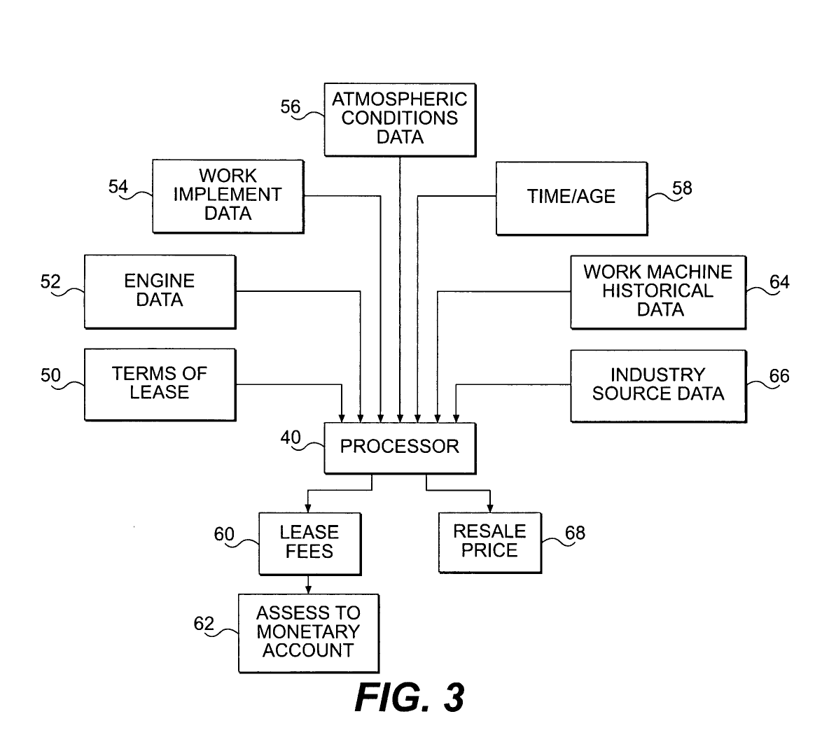

FIG. 3 diagrammatically illustrates at least some of the various factors that may be considered by processor 40 in determining lease fees and/or resale price of machine 12. Processor 40 may consider the terms of the lease agreement (“Terms of Lease” block 50), as well as data acquired for any operating conditions, such as engine operation data 52, work implement operation data 54, atmospheric conditions data 56, etc. In addition, processor 40 may consider the time in service and/or age (“Time/Age” block 58) of machine 12.

Any number of these factors, as well as others may be considered in determining fees associated with a lease (“Lease Fees” block 60). Such fees may include the lease rates (e.g., the monthly payments). Other types of lease fees may include fees for excess and/or harsh use of machine 12 (such fees may also be referred to as penalties or surcharges). For example, processor 40 may be configured to compare engine data 52 to the terms of the lease agreement (block 50) to determine whether a lessee is operating or has operated machine 12 more than an amount agreed to in the lease agreement. Any use not contracted for may trigger a fee. The increased use may also trigger a recalculation of the lease rate. That is, the monthly payments may be adjusted (e.g., increased) to compensate for the additional depreciation that machine 12 will likely incur as a result of the increased use. Determination and/or assessment of such fees may take place in real time.

System 10 may be configured to offer changes to one or more terms of a lease agreement to a lessee of machine 12 based on data collected by data collection devices 14. Further, system 10 may be configured to automatically make changes to one or more terms of a lease agreement to a lessee of machine 12 based on the collected data. System 10 may also be configured to notify an owner, operator, or any other interested party of changes to the terms of the lease agreement.

System 10 may include a monetary account linked to the operation of machine 12 and configured to satisfy the fees associated with the lease. Such an account may include a debit account or a credit account. For example, a lease may be tied to a credit card account opened by the lessee through the lessor (owner). When system 10 determines that fees are owed, system 10 may assess the fees to the monetary account (block 62).

Other machine historical data 64 and/or industry source data 66 may be considered by processor 40 in determining a resale price (block 68) of machine 12, for example, at the end of a lease term or upon termination of the lease. Exemplary historical data 64 may include, for example, the number of owners of machine 12. Industry source data 66 may include, for example, industry averages for resale prices or market values (e.g., trade-in, private sale, and/or retail values). In some embodiments, industry source data 66 may serve as a starting point for resale price, which may be adjusted up or down depending on the data acquired by system 10.

System 10 may also be configured to utilize the data from data collection devices 14 to develop a financing plan for financing a machine. The financing plan may be for purchasing a machine or leasing a machine. Such a financing plan may be for machine 12 itself or for future financial transactions involving similar machines.

### INDUSTRIAL APPLICABILITY

The disclosed asset management system may be applicable for management of any kind of mechanical equipment asset for which operating data may be retrieved. For example, the disclosed system may be used for management of machines, such as heavy duty equipment (e.g., excavators, track-type tractors, loaders, power generation sets, etc.) and/or light duty equipment (e.g., passenger vehicles, small-sized electric generators, lawn and garden tractors, etc.). Further, the disclosed system may be used to manage a fleet of one or more different types of machines.

Such machines may be leased under agreements that specify what kind and how much work the machine will be used to perform over the term of the lease. For example, the machines may be leased under terms that specify how many hours the machines will be operated per a unit of time (e.g., day, month, year, etc.). In addition, the lease agreement may specify a type of work that the machine will be used to perform, such as heavy construction, building construction, mining, forestry, paving, industrial, governmental, or any other type of work.

The disclosed system may be utilized for on-site monitoring of machines at a worksite. Data may be retrieved and analyzed on location at the worksite. Alternatively or additionally, the disclosed system may be utilized for monitoring of machines from a remote location. Data may be analyzed at a processing center remote from the machine, such as a service or management center. For such remote analysis, the data may be retrieved on location at the worksite or delivered to processing center via a data transfer link (e.g., satellite communication).

The retrieved data may be examined by an individual (e.g., an owner, operator, service technician, etc.) or by the disclosed system itself to monitor any of a number of operating parameters. The disclosed system may be utilized to process this data and determine lease fees and/or resale pricing of a machine.

An exemplary method of using the disclosed system may include directly monitoring operation of at least one component of the machine including collecting data for one or more operating conditions of the machine. The directly monitored operation of the at least one component may be directly indicative of a harshness with which the machine is operated. An exemplary method may further include predicting a future market value of the machine based on the collected data, as well as determining fees associated with the lease in real time based on the predicted future market value. An exemplary method may also include determining a resale price of the machine based on the predicted market value.

An exemplary method of using the disclosed system may include offering changes to one or more terms of a lease agreement to a lessee of the machine based on the collected data. Further, the method may also include automatically making changes to one or more terms of the lease agreement based on the collected data.

An exemplary method of using the disclosed system may include monitoring and collecting data for one or more operating parameters of the machine. In some embodiments, the method may include monitoring and collecting data for operating parameters of the machine, geographic parameters, and/or atmospheric conditions.

An exemplary method of using the disclosed system may include utilizing the collected data to develop a financing plan for financing a machine. Such utilization may include developing financing plans for purchasing or leasing the same machine from which data is collected. Alternatively or additionally, such utilization may include developing financing plans for future financial transactions involving similar machines.

An exemplary method of using the disclosed system may include making data and/or analysis, such as a predicted future market value available to an owner and/or an operator of the machine. For example, alerts or warnings may be provided to the owner and/or operator to make them aware of any use of the machine that was not contracted for. Such alerts, particularly those sent to the operator (e.g., a lessee), could be used to promote use in compliance with the lease or other type of use agreement (e.g., rental). Such alerts may be displayed on the machine in some fashion readily accessible by the operator, such as a display (not shown) at the operator station. Alternatively, or additionally, the alerts could be used to notify the operator of changes that have been made to the terms of the lease agreement as a result of operation not in compliance with the original agreement. The alerts may also notify the operator of any fees or changes to the lease rate associated with the changed lease terms.

For example, if an original lease agreement provides for 160 hours of use for each month in exchange for a monthly payment of $2000, and data acquisition indicates that a user utilized the leased machine for 200 hours in a month, changes may be made to the lease agreement. The adjusted agreement may set the maximum allowable hours to 225 and increase the monthly payments to $3000. Such changes may be preceded by warnings, fees, and/or other deterrents. The changes, warnings, fees, and any other details regarding the lease agreement may be communicated to the operator. In some embodiments, such communication may be in real time.

An exemplary method of using the disclosed system may include making data and/or analysis, such as a predicted future market value available to at least one entity other than an owner of the machine. For example, such a method may include making the predicted future market value available to an entity that provides an industry source for resale values of machines.

An exemplary method of using the disclosed system may include linking a monetary account to operation of the machine and satisfying fees associated with a lease using the linked monetary account.

By monitoring operation of one or more components directly, a more accurate and detailed determination may be made regarding the harshness with which the machine is used. Whereas systems that monitor a general parameter, such as vibration, provide minimal insight into the actual harshness with which a machine is operated, the disclosed system may directly determine and, in some embodiments, quantify operating conditions that directly indicate the harshness with which the machine is operated. More accurate determination of harshness of operation may enable a more accurate determination of the true value of the machine to be made.

One way in which directly monitoring machine components allows for more accurate determinations of machine value is by pinpointing or substantially pinpointing the components or systems of a machine that have experienced the harshest use. By pinpointing the aspects of a machine that have experienced the most stress, one can either adjust a resale price accordingly, or perform any appropriate maintenance to the most heavily stressed components to warrant a higher resale price.

It will be apparent to those having ordinary skill in the art that various modifications and variations can be made to the disclosed asset management system without departing from the scope of the invention. Other embodiments of the invention will be apparent to those having ordinary skill in the art from consideration of the specification and practice of the invention disclosed herein. It is intended that the specification and examples be considered as exemplary only, with a true scope of the invention being indicated by the following claims and their equivalents.

What is claimed is:

1. An asset management system, comprising:
one or more data collection devices configured to monitor one or more operating conditions of a leased machine;
wherein at least one of the one or more data collection devices is configured to directly monitor operation of at least one component of the machine to determine the harshness with which the machine is operated; and
a processor configured to:
receive data from the one or more data collection devices;
determine a value of the machine based on the data from the one or more data collection devices; and
determine fees associated with the lease in real time based on the data from the one or more data collection devices.

2. The system of claim 1, wherein the one or more operating conditions includes operating parameters of the machine.

3. The system of claim 1, wherein the one or more operating conditions includes at least two of the following:
operating parameters of the machine;
geographic parameters; and
atmospheric conditions.

4. The system of claim 1, wherein the directly monitored operation of the at least one component of the machine includes at least one of the following operating conditions:
work implement repetitions;
work implement speed; and
work implement load.

5. The system of claim 1, wherein the operation of the at least one component of the machine includes at least one of the following operating conditions:
fluid temperature;
fluid pressure; and
fluid level.

6. The system of claim 1, wherein the operation of the at least one component of the machine includes at least one of the following operating conditions:
payload; and
roughness of terrain.

7. The system of claim 1, wherein the system is configured to offer changes to one or more terms of a lease agreement to a lessee of the machine based on the collected data.

8. The system of claim 1, wherein the system is configured to automatically make changes to one or more terms of a lease agreement to a lessee of the machine based on the collected data.

9. The system of claim 1, wherein the system is configured to utilize the data from the data collection devices to develop a financing plan for financing a machine.

10. The system of claim 9, wherein the financing plan is for at least one of purchasing a machine and leasing a machine.

11. The system of claim 1, wherein the system is configured to make the determined value available to at least one entity other than an owner of the machine.

12. The system of claim 11, wherein the at least one entity includes an entity that provides an industry source for resale values of machines.

13. The system of claim 11, wherein the at least one entity includes an operator who leases the machine.

14. The system of claim 1, wherein a monetary account is linked to operation of the machine and configured to satisfy the fees associated with the lease.

15. The system of claim 14, wherein the monetary account is selected from the group consisting of a debit account and a credit account.

16. A method of determining a resale price of a leased machine, comprising:
directly monitoring operation of at least one component of the machine including collecting data for one or more operating conditions of the machine;
wherein the monitored operation of the at least one component is directly indicative of a harshness with which the machine is operated;
determining a value of the machine based on the collected data; and
determining fees associated with the lease in real time based on the collected data.

17. The method of claim 16, wherein the one or more operating conditions includes operating parameters of the machine.

18. The method of claim 16, wherein the one or more operating conditions includes at least two of the following:
operating parameters of the machine;
geographic parameters; and
atmospheric conditions.

19. The method of claim 16, wherein the directly monitoring operation of the at least one component of the machine includes monitoring at least one of the following operating conditions:
work implement repetitions;
work implement speed; and
work implement load.

20. The method of claim 16, wherein the directly monitoring operation of the at least one component of the machine includes monitoring at least one of the following operating conditions:
fluid temperature;
fluid pressure; and
fluid level.

21. The method of claim 16, wherein the directly monitoring operation of the at least one component of the machine includes monitoring at least one of the following operating conditions:
payload; and
roughness of terrain.

22. The method of claim 16, further including offering changes to one or more terms of a lease agreement to a lessee of the machine based on the collected data.

23. The method of claim 16, further including automatically making changes to one or more terms of a lease agreement to a lessee of the machine based on the collected data.

24. The method of claim 16, further including utilizing the collected data to develop a financing plan for financing a machine.

25. The method of claim 24, wherein the financing plan is for at least one of purchasing a machine and leasing a machine.

26. The method of claim 16, further including making the determined value available to at least one entity other than an owner of the machine.

27. The method of claim 26, wherein the at least one entity includes an entity that provides an industry source for resale values of machines.

28. The method of claim 26, wherein the at least one entity includes an operator who leases the machine.

29. The method of claim 16, further including linking a monetary account to operation of the machine and satisfying the fees associated with the lease using the linked monetary account.

30. The method of claim 29, wherein the monetary account is selected from the group consisting of a debit account and a credit account.

31. A machine, comprising:
a frame; and
a power source mounted to the frame;
wherein the machine is integrated with an asset management system including:
one or more data collection devices configured to monitor one or more operating conditions of a leased machine;
wherein at least one of the one or more data collection devices is configured to directly monitor operation of at least one component of the machine to determine the harshness with which the machine is operated; and
a processor configured to:
receive data from the one or more data collection devices;
determine a value of the machine based on the data from the one or more data collection devices; and
determine fees associated with the lease in real time based on the data from the one or more data collection devices.

32. The machine of claim 31, wherein the one or more operating conditions includes at least two of the following:
operating parameters of the machine;
geographic parameters; and
atmospheric conditions.

33. The machine of claim 31, wherein the system is configured to utilize the data from the data collection devices to develop a plan for financing machines.

34. The machine of claim 31, wherein the directly monitored operation of the at least one component of the machine includes at least one of the following operating conditions:
work implement repetitions;
work implement speed; and
work implement load.

35. The machine of claim 31, wherein the operation of the at least one component of the machine includes at least one of the following operating conditions:
fluid temperature;
fluid pressure; and
fluid level.

36. The machine of claim 31, wherein the operation of the at least one component of the machine includes at least one of the following operating conditions:
payload; and
roughness of terrain.

37. The machine of claim 31, wherein the system is configured to offer changes to one or more terms of a lease agreement to a lessee of the machine.

38. The machine of claim 31, wherein the system is configured to automatically make changes to one or more terms of a lease agreement to a lessee of the machine.

39. The machine of claim 31, wherein the system is configured to make the determined value available to an entity that provides an industry source for resale values of machines.

40. The machine of claim 31, wherein a monetary account is linked to operation of the machine and configured to satisfy the fees associated with the lease.

41. The machine of claim 31, wherein the processor is located in one of the following locations:
on the machine;
remote from the machine and at a work site where the machine is located; and
remote from a work site where the machine is located.
